(19) United States
(12) Patent Application Publication
(10) Pub. No.: US 2021/0067369 A1
(43) Pub. Date: Mar. 4, 2021

(54) VEHICLE SENSOR NETWORK SYSTEM AND METHOD

(71) Applicant: Toyota Motor Engineering & Manufacturing North America, Inc., Plano, TX (US)

(72) Inventor: Ryan M. Wiesenberg, Ann Arbor, MI (US)

(21) Appl. No.: 16/553,323

(22) Filed: Aug. 28, 2019

(51) Int. Cl. H04L 12/407; H04L 12/40; G05D 1/00

(52) U.S. Cl. CPC H04L 12/407; H04L 12/40032; G05D 1/0231; H04L 2012/40273; G05D 1/0088

(57) ABSTRACT

A sensor node includes one or more processors, a sensing element and a memory device, both of which are in communication with the one or more processors. The sensing element senses a condition and generates sensor data based on the sensed condition. The memory device may store a communications module having instructions that when executed by the one or more processors causes the one or more processors to receive input data from a first external sensor node that the sensor node is subscribed to and publish output data to a second external sensor node that is subscribed to the sensor node. The output data may include data regarding the condition sensed by the sensing element.

### TECHNICAL FIELD

The subject matter described herein relates, in general, to sensor networks and related methods, and more particularly to sensor networks and related methods for vehicles.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

Some vehicles, especially autonomous and semi-autonomous vehicles, have sensors to detect the environment surrounding the vehicle. These sensors may be configured so that they output raw sensor data to an electronic control unit, which may then fuse together data collected. Once the electronic control unit fuses data, the data may then be passed to one or more vehicle systems and subsystems.

### SUMMARY

This section generally summarizes the disclosure and is not a comprehensive explanation of its full scope or all its features.

In one embodiment, a network system includes a data bus, a first sensor node, a second sensor node, and a third sensor node. The first, second, and third sensor nodes are in communication with the data bus. The first sensor node may include one or more processors, a sensing element, and a memory device. Both the sensing element and the memory device are in communication with the one or more processors of the first sensor node. The sensing element is configured to sense at least one condition and generate sensor data based on the sensed at least one condition.

The memory device of the first sensor node has a communications module that includes instructions that cause the one or more processors to receive input data from the second sensor node that the first sensor node is subscribed to via the data bus. The input data may include data regarding at least one condition sensed by the second sensor node. In addition, the communications module also causes the one or more processors of the first sensor node to publish output data to a third sensor node that is subscribed to the first sensor node. The output data may include data regarding the at least one condition sensed by the sensing element.

In another embodiment, a method for communication in a sensor network includes the steps of receiving input data, by a first sensor node, from a second sensor node that the first sensor node is subscribed to, and publishing, by the first sensor node, output data to a third sensor node that is subscribed to the first sensor node. The input data may include data regarding at least one condition sensed by the second sensor node. The output data may include data regarding the at least one condition sensed by a sensing element of the first sensor node

In another embodiment, a sensor node includes one or more processors, a sensing element and a memory device, both of which are in communication with the one or more processors. The sensing element senses a condition and generates sensor data based on the sensed condition. The memory device may store a communications module having instructions that when executed by the one or more processors causes the one or more processors to receive input data from a first external sensor node that the sensor node is subscribed to and publish output data to a second external sensor node that is subscribed to the sensor node. The output data may include data regarding the condition sensed by the sensing element.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a block diagram of a vehicle incorporating a network system;

FIG. 2 illustrates a more detailed block diagram of the network system;

FIG. 3 illustrates one example of a method for communication within the network system; and

FIG. 4 illustrates an example of another method for communication within the network system.

### DETAILED DESCRIPTION

Described is a network system that may be used within a vehicle. The network system may be made up of a plurality of sensor nodes that utilize a publish-subscribe system to communicate with one another and other components connected to the network system. The sensor nodes communicate with one another and other vehicle systems by publishing data to a data bus. The published data has an identifier that indicates to subscribers that are also connected to the data bus that the published data should be received by them. By utilizing a publish-subscribe system, multiple sensor nodes and other components can be grouped together and can receive relevant data by simply having the sensor nodes and other components that form the group have the same subscriber identifier.

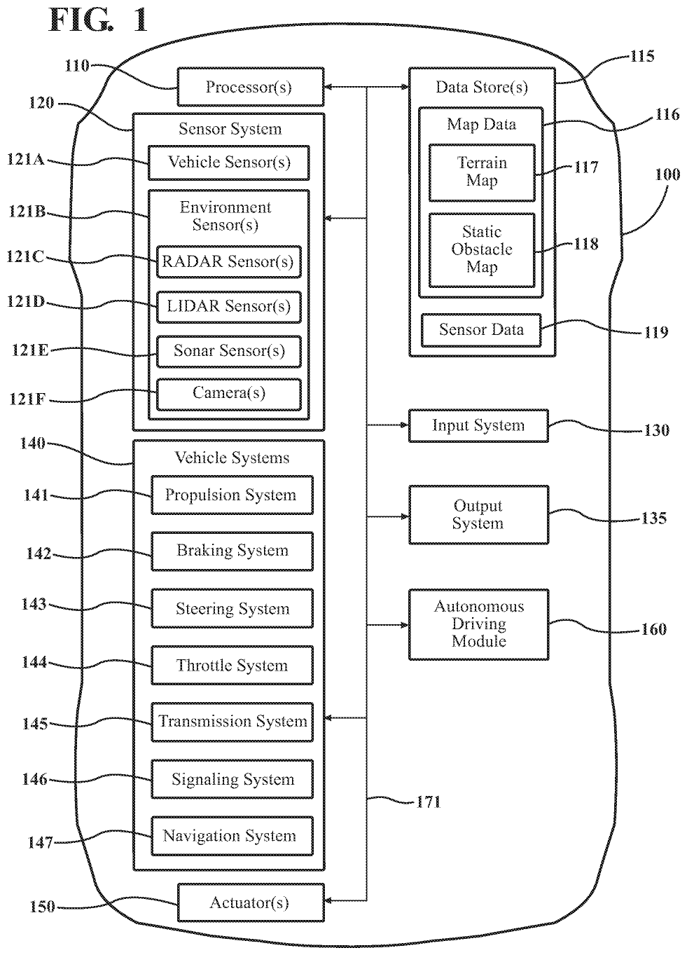

Referring to FIG. 1, an example of a vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any robotic device or form of powered transport that, for example, includes one or more automated or autonomous systems, and thus benefits from the functionality discussed herein. The sensor network system that will be described in this disclosure may be applicable to a vehicle, such as the vehicle 100, but may be equally applicable to not vehicle applications.

In various embodiments, the automated/autonomous systems or combination of systems may vary. For example, in one aspect, the automated system is a system that provides autonomous control of the vehicle according to one or more levels of automation such as the levels defined by the Society of Automotive Engineers (SAE) (e.g., levels 0-5). As such, the autonomous system may provide semi-autonomous control or fully autonomous control as discussed in relation to the autonomous driving module 160.

The vehicle 100 also includes various elements. It will be understood that in various embodiments it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances and provided as remote services (e.g., cloud-computing services).

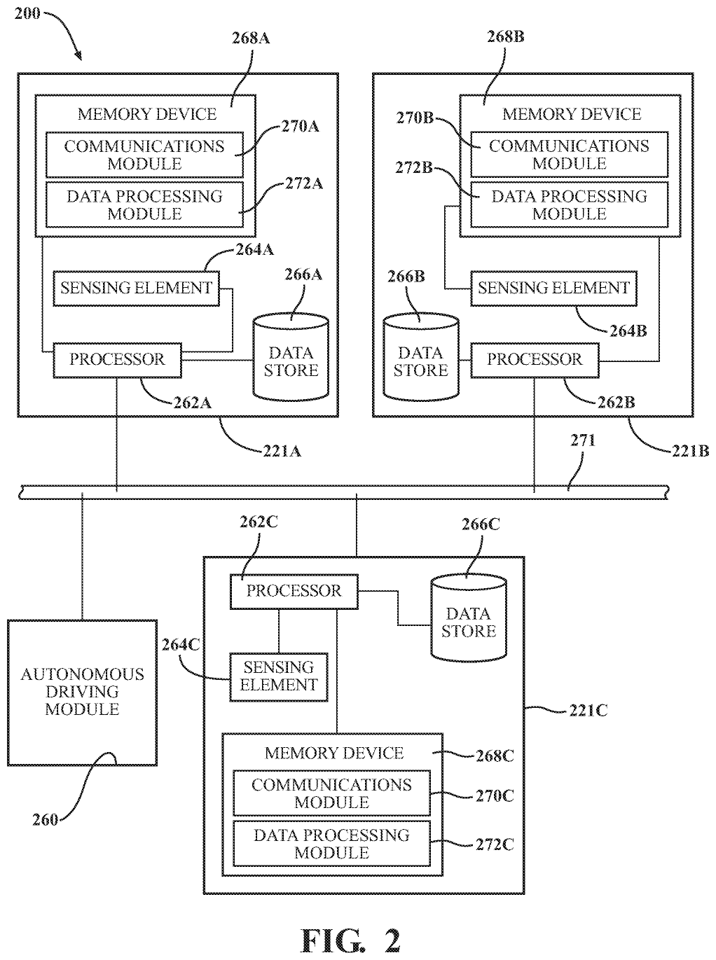

Some of the possible elements of the vehicle 100 are shown in FIG. 1 and will be described along with subsequent figures. However, a description of many of the elements in FIG. 1 will be provided after the discussion of FIGS. 2-4 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. It should be understood that the embodiments described herein may be practiced using various combinations of these elements.

The vehicle 100 can include the sensor system 120. The sensor system 120 can include one or more sensor nodes. “Sensor” and/or “sensor node” means any device, component and/or system that can detect, and/or sense something. The one or more sensor nodes can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensor nodes, the sensor nodes can work independently from each other. Alternatively, two or more of the sensor nodes can work in combination with each other. In such a case, the two or more sensor nodes can form a sensor communications network. The sensor system 120 and/or the one or more sensor nodes can be operatively connected to the processor(s) 110, the data store(s) 115, and/or another element of the vehicle 100 (including any of the elements shown in FIG. 1). The sensor system 120 can acquire data of at least a portion of the external environment of the vehicle 100 (e.g., nearby vehicles).

The sensor system 120 can include any suitable type of sensor nodes. Various examples of different types of sensors will be described herein. However, it will be understood that the embodiments are not limited to the particular sensors described. The sensor system 120 can include one or more vehicle sensor nodes 121A. The vehicle sensor node(s) 121A can detect, determine, and/or sense information about the vehicle 100 itself. In one or more arrangements, the vehicle sensor node(s) 121A can be configured to detect, and/or sense position and orientation changes of the vehicle 100, such as, for example, based on inertial acceleration. In one or more arrangements, the vehicle sensor node(s) 121A can include one or more accelerometers, one or more gyroscopes, an inertial measurement unit (IMU), a dead-reckoning system, a global navigation satellite system (GNSS), a global positioning system (GPS), a navigation system 147, and/or other suitable sensor nodes. The vehicle sensor node(s) 121A can be configured to detect, and/or sense one or more characteristics of the vehicle 100. In one or more arrangements, the vehicle sensor node(s) 121A can include a speedometer to determine a current speed of the vehicle 100.

Alternatively, or in addition, the sensor system 120 can include one or more environment sensor nodes 121B configured to acquire, and/or sense driving environment data. “Driving environment data” includes data or information about the external environment in which an autonomous vehicle is located or one or more portions thereof. For example, the one or more environment sensor nodes 121B can be configured to detect, quantify and/or sense obstacles in at least a portion of the external environment of the vehicle 100 and/or information/data about such obstacles. Such obstacles may be stationary objects and/or dynamic objects. The one or more environment sensor nodes 121B can be configured to detect, measure, quantify and/or sense other things in the external environment of the vehicle 100, such as, for example, lane markers, signs, traffic lights, traffic signs, lane lines, crosswalks, curbs proximate the vehicle 100, off-road objects, etc.

Various examples of sensor nodes of the sensor system 120 will be described herein. The example sensor nodes may be part of the one or more environment sensor nodes 121B and/or the one or more vehicle sensor nodes 121A. However, it will be understood that the embodiments are not limited to the particular sensor nodes described.

As an example, in one or more arrangements, the sensor system 120 can include one or more radar sensor nodes 121C, one or more LIDAR sensor nodes 121D, one or more sonar sensor nodes 121E, and/or one or more camera sensor nodes 121F. In one or more arrangements, the one or more sensor nodes 121F can be high dynamic range (HDR) cameras or infrared (IR) cameras.

With reference to FIG. 2, an example of a network system 200 is shown. In this example, like reference numerals have been utilized refer to like components, with the exception that the reference numerals have been increased by 100. For example, the autonomous driving module 260 of FIG. 2 may be similar to the autonomous driving module 160 of FIG. 1. The network system 200 includes a first sensor node 221A, a second sensor node 221B, a third sensor node 221C, and an autonomous driving module 260 that are in communication with the data bus 271. The data bus 271 may be any type of data bus that allows the communication between one or more electronic components that are connected or otherwise in communication with the data bus 271. In one example, the data bus 271 may be a controller area network type data bus. However, it should be understood that any type of data bus may be utilized.

Also, it should be understood that the network system 200 is but one example of an implementation of one or more sensor nodes. As such, the network system 200 may include any number of sensor nodes. Furthermore, it should also be understood that any of the devices shown in FIG. 1 could also be connected to the data bus 271 and thus be part of the network system 200. As such, other modules and/or electronic systems and subsystems in addition to or alternatively to the autonomous driving module 260 could be in communication with the data bus 271.

The first sensor node 221A, the second sensor node 221B, and the third sensor node 221C may be similar to any of the sensor nodes previously described, such as sensor nodes 121A-121F. As such, it should be understood that the sensor nodes 221A-221C may be any type of sensor node, such as a camera sensor node, a LIDAR sensor node, radar sensor node, sonar sensor node, or any of the other sensor nodes previously described. Furthermore, it should also be understood that the sensor nodes 221A-221C may also be of a similar type. For example, sensor nodes 221A and 221B may both be camera sensor nodes, while the third sensor node 221C may be a radar sensor node.

The first sensor node 221A may include one or more processors 262A that may be in communication with a sensing element 264A, a data store 266A and/or a memory device 268A. The components of the second sensor node 221B and/or third sensor node 221C may be similar to components of the first sensor node 221A. As such, any description regarding the components of the first sensor node 221A may be equally applicable to the second sensor node 221B and/or the third sensor node 221C.

The sensing element 264A may be an element that is capable of sensing a condition experienced by the sensor node 221A. The sensing element 264A may be any type of sensor described in this disclosure. For example, the sensor element 264A may be a radar sensor, LIDAR sensor, sonar sensor, camera sensor, or combination thereof. Furthermore, the sensor element 264A may include more than one sensor element. In one example, the sensor element 264A may be a stereoscopic camera that includes two camera sensors.

The data store 266A can include volatile and/or non-volatile memory. Examples of suitable data stores 266A include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 266A can be a component of the processor(s) 262A, or the data store 266A can be operatively connected to the processor(s) 262A for use thereby. The term “operatively connected” and/or “in communication with” as used throughout this description, can include direct or indirect connections, including connections without direct physical contact. The data store 266A may be utilized to collect and store information generated by the sensing element 264A and/or received from other components from the data bus 271. Furthermore, the data store 266A may also store information generated by the one or more processors 262A.

The memory device 268A may be any type of memory capable of storing information that can be utilized by the one or more processors 262A. As such, the memory device 268A may be a solid-state memory device, magnetic memory device, optical memory device, and the like. In this example, the memory device 268A is separate from the one or more processors 262A, but it should be understood that the memory device 268A may be incorporated within any of the one or more processors 262A, as opposed to being a separate device.

The memory device 268A may be capable of storing one or more modules that when executed by the one or more processors 262A cause the one or more processors 262A to perform any one of a number of different methods disclosed in this disclosure. In this example, the memory device 268A includes a communications module 270A and a data processing module 272A. The modules 270A and/or 270B can be a component of the one or more processors 262A, or one or more of the modules 270A and/or 270B can be executed on and/or distributed among other processing systems to which the one or more processors 262A are operatively connected.

The communications module 270A may have instructions that when executed by the one or more processors 262A causes the one or more processors 262A to perform any one of a number of different methodologies described in this disclosure. In one example, the communications module 270A causes the one or more processors 262A to receive input data from the second sensor node 221B and/or the third sensor node 221C and/or any electronic component or subcomponent that the first sensor node 221A is subscribed to.

Moreover, the communications module 270A configures the one or more processors 262A to utilize a publish-subscribe messaging system. Components that provide data to the data bus 271 may be referred to as publishers. These publishers categorized the publish information into classes. The categorizing of these publish messages into classes may be done without knowledge of which subscribers, if any, there may be. In similar manner, subscribers express interest in one or more classes and receive only information that is of interest, without knowledge of which publishers, if any, there are.

In the example stated above, the first sensor node 221A is a subscriber to a class of information that may be generated by the second sensor node 221B. In this situation, the second sensor node 221B publishes information and the first sensor node 221A subscribes to this published information. As such, the communications module 270A configures the one or more processors 262A to receive information that the first sensor node 221A is subscribed to.

The communications module 270A may also configure the one or more processors 262A of the first sensor node 221A to publish output data to any component that is subscribed to the first sensor node 221A. In one example, the subscribing device may be the third sensor node 221C. As such, when the first sensor node 221A publishes information to the data bus 271, the third sensor node 221C will receive this information. Conversely, if one assumes that the second sensor node 221B is not a subscriber to the first sensor node 221A, the second sensor node 221B will not receive the information published by the first sensor node 221A.

It should be understood that there may be multiple combinations and/or designations of what components that are in communication with the data bus 271 are publishers and/or subscribers. In the example above, the first sensor node 221A is a subscriber to the second sensor node 221B, but is a publisher to the third sensor node 221C. However, the sensor nodes 221A, 221B, and/or 221C may be publishers to certain components and subscribers to other components. Furthermore, it should be understood that the sensor nodes 221A, 221B, and/or 221C may be publishers and subscribers to each other. For example, if the sensor node 221A and the sensor node 221B both publish to and subscribe to each other, data generated by the first sensor node 221A would be published to the second sensor node 221B, and, data published by the second sensor node 221B would be published to the first sensor node 221A.

The publish-subscribe system applies to other components as well. In this example, the autonomous driving module 260 may be a subscriber to all three of the sensor nodes 221A, 221B, and 221C. As such, the autonomous driving module 260 will receive information published by the sensor nodes 221A, 221B, and 221C.

Additionally, other electrical components may also use the publish-subscribe system. For example, the vehicle systems 140 may be subscribers to information generated by the autonomous driving module 160. The output system 135 and/or actuators 150 may be a subscriber to the autonomous driving module 160 and the processor(s) 110. As stated before, any conceivable combination could be utilized. This may allow one to essentially group like electronic components together. For example, the sensor nodes making up the sensor system 120 may each be subscribers to each other, thereby allowing each other to communicate with each other. Further, the autonomous driving module 160 may be a subscriber to any of the sensor nodes making up the sensor system 120. If additional sensor nodes are added and publish the same category of information, this information will be provided to any subscribers, such as the autonomous driving module 160.

The data processing module 272A may contain instructions that configure the one or more processors 262A to process data generated by the sensing element 264A and/or data received from the data bus 271. In one example, the data processing module 272A may configure the one or more processors 262A to compare input data received from the data bus 271 with data generated by the sensing element 264A of the first sensor node 221A. In one example, assume that the first sensor node 221A is subscribed to the second sensor node 221B and vice versa. Also, assume that the sensing elements 264A of the first sensor node 221A and the sensing element 264B of the second sensor node 221B have an overlapping field-of-view. In such an arrangement, some of the data generated by the sensing elements 264A and 264B of the overlapping field-of-view should agree with each other.

Here, the first sensor node 221A may receive input data from the second sensor node 221B which may be related to measurements taken by the sensing element 264B of the second sensor node 221B. The one or more processors 262A compare the input data received from the second sensor node 221B to information generated by the sensing element 264A. If it is determined that the input data from the second sensor node 221B generally agrees with the information generated by the sensing element 264A of the first sensor node 221A, the one or more processors 262A may determine that one or both of the sensor nodes 221A and/or 221B are operating properly.

If the second sensor node 221B is subscribed to the first sensor node 221A, the second sensor node 221B could perform a similar operation, wherein input data generated by the sensing element 264A of the first sensor node 221A is compared to sensor data generated by the sensing element 264B. Similarly, the one or more processors 262B of the second sensor node 221B may determine that one or both of the sensor nodes 221A and/or 221B are working properly.

If the one or more processors 262A of the first sensor node 221A determines that there is a discrepancy, the data processing module 272A may configure the one or more processors 262A of the first sensor node 221A to output a data discrepancy signal. This data discrepancy signal is published to the data bus 271 and will, therefore, be provided to any component in communication with the data bus 271 that is subscribed to the first sensor node 221A. In this example, the autonomous driving module 260 may be a subscriber to the first sensor node 221A and will therefore receive this data discrepancy error signal indicating that one or more the sensor nodes may be malfunctioning or be providing improper information and then may make adjustments to the algorithms used to control the operation of the vehicle 100.

The data processing module 272A may also configure the processor 262A to aggregate data received from another component that the first sensor node 221A is subscribed to. Thereafter, the first sensor node 221A may then publish the aggregated data to the data bus 271 so that subscribers to the first sensor node 221A can receive the aggregated information.

For example, assume that the first sensor node 221A is a subscriber to the second sensor node 221B. Here, the data processing module 272A may configure the one or more processors 262A to receive input data from the second sensor node 221B. From here, the data processing module 272A may then aggregate or fuse data received from the second sensor node 221B with additional data generated by the sensing element 264A. This fused data may then be published by the first sensor node 221A and provided to any subscribers of the first sensor node 221A. In this example, the autonomous driving module 260 may be a subscriber to the first sensor node 221A but not the second sensor node 221B. The information generated by the sensing element 264B of the second sensor node 221B is first provided to the first sensor node 221A. The first sensor node 221A takes the information from the second sensor node 221B and fuses it with data generated by the sensing element 264A before passing along to the autonomous driving module 260. As such, the fusion of data is offloaded from the autonomous driving module 260 and is performed by the first sensor node 221A. This may be advantageous in offloading some of the computational complexities of fusing data from the autonomous driving module 260 and onto the sensor nodes 221A, 221B, and/or 221C, freeing up the processing power of the autonomous driving module 260 to perform other operations.

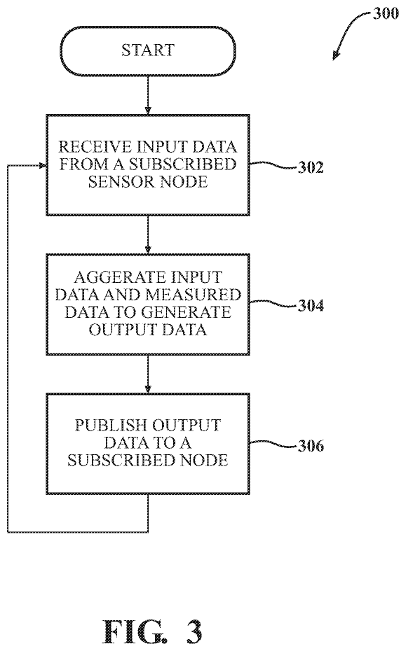

Referring to FIG. 3, a method 300 for communication in a network system is shown. While the method 300 is discussed in combination with the network system 200, it should be appreciated that the method 300 is not limited to being implemented within the network system 200 but is instead one example of a network system that may implement the method 300.

In step 302, the communications module 270A may cause the one or more processors 262A to receive input data from a sensor node that the first sensor node 221A is subscribed to, such as the second sensor node 221B. After receiving the input data, the method 300 proceeds to step 304, wherein the data processing module 272A may then configure the one or more processors 262A to aggregate or fuse the input data with data measured by the sensing element 264A. This aggregation or fusion of the input data with the measured data generates output data.

In step 306, the data processing module 272A may then configure the one or more processors 262A to publish the output data to a node that is subscribed to the first sensor node 221A. Here, as stated before, the output data is essentially fused data and may include portions of the input data from the second sensor node 221B and information generated by the sensing element 264A of the first sensor node 221A. The output data is published to whichever components are subscribers to the first sensor node 221A. In one example, the autonomous driving module 260 may be a subscriber to the first sensor node 221A and will, therefore, be provided the output data from the first sensor node 221A. Thereafter, the method may return to step 302 or end.

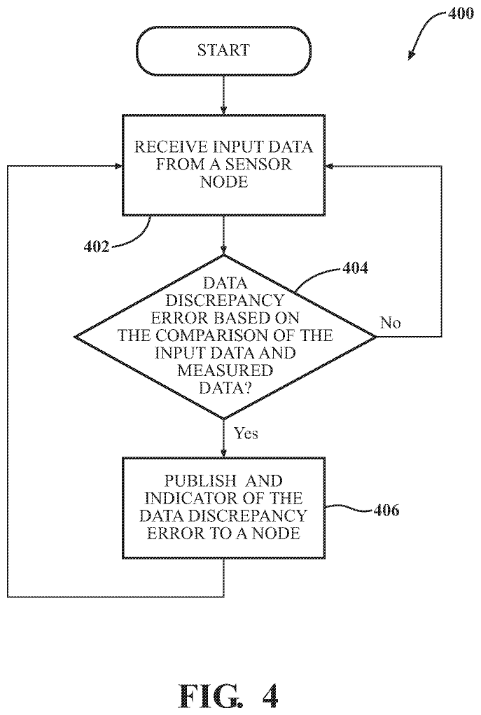

Referring to FIG. 4, another method 400 for communication in a network system is shown. While the method 400 is discussed in combination with the network system 200, it should be appreciated that the method 400 is not limited to being implemented within the network system 200 but is instead one example of a system that may implement the method 400.

In the method 400, data generated by the second sensor node 221B will be compared by the first sensor node 221A with data generated from the sensing element 264A. In this example, the sensing element 264A of the first sensor node 221A may have a field-of-view that overlaps the field-of-view of the sensing element 264B of the second sensor node 221B. As such, the first sensor node 221A can perform a comparison of data generated by sensing elements 264A and 264B of the overlapping area and determine if there are any errors and/or if the sensor nodes 221A and/or 221B are operating properly.

In step 402, the communications module 270A configures the one or more processors 262A to receive input data from a sensor node to which it is subscribed. In this example, the first sensor node 221A is subscribed to the second sensor node 221B and receives input data from the second sensor node 221B. The input data from the second sensor node 221B may include data generated by the sensing element 264B of the second sensor node 221B

In step 404, the data processing module 272A configures the one or more processors 262A to make a determination if there is a data discrepancy error. This determination is made by comparing the input data from the second sensor node 221B with measured data generated by the sensing element 264A. As previously described, in this example, there is an overlap of the fields-of-view of the sensing element 264A and the sensing element 264B. The one or more processors 262A are configured by the data processing module 272A to compare the input data with the measured data and determine if there is agreement in the data. If the data is not in agreement, the method proceeds to step 406. Otherwise, the method will return to step 402 or end.

In step 406, the data processing module 272A configures the one or more processors 262A to publish an indicator of the data discrepancy error onto the data bus 271. As such, the data discrepancy error indicates that there was an error determined by the first sensor node 221A. In one example, the autonomous driving module 260 may be a subscriber to first sensor node 221A and would, therefore, receive the indicator of the data discrepancy error. From there, the autonomous driving module 260 may modify the operation of the vehicle 100 based on the presence of the indicator of the data discrepancy error.

FIG. 1 will now be discussed in full detail as an example environment within which the system and methods disclosed herein may operate. In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle 100 along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangements, the map data 116 can include one or more terrain map(s) 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data stores 115 can include sensor data 119. In this context, “sensor data” means any information about the sensor nodes that the vehicle 100 is equipped with, including the capabilities and other information about such sensor nodes. The sensor data 119 can relate to one or more sensor nodes of the sensor system 120. 1

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

The vehicle 100 can include an input system 130. An “input system” includes any device, component, system, element or arrangement or groups thereof that enable information/data to be entered into a machine. The input system 130 can receive an input from a vehicle passenger (e.g., a driver or a passenger). The vehicle 100 can include an output system 135. An “output system” includes any device, component, or arrangement or groups thereof that enable information/data to be presented to a vehicle passenger (e.g., a person, a vehicle passenger, etc.).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system or a geolocation system.

The processor(s) 110 and/or the autonomous driving module(s) 160 can be operatively connected to communicate with the various vehicle systems 140 and/or individual components thereof. For example, returning to FIG. 1, the processor(s) 110 and/or the autonomous driving module(s) 160 can be in communication to send and/or receive information from the various vehicle systems 140 to control the movement, speed, maneuvering, heading, direction, etc. of the vehicle 100. The processor(s) 110 and/or the autonomous driving module(s) 160 may control some or all of these vehicle systems 140 and, thus, may be partially or fully autonomous.

The processor(s) 110 and/or the autonomous driving module(s) 160 can be operatively connected to communicate with the various vehicle systems 140 and/or individual components thereof. For example, returning to FIG. 1, the processor(s) 110 and/or the autonomous driving module(s) 160 can be in communication to send and/or receive information from the various vehicle systems 140 to control the movement, speed, maneuvering, heading, direction, etc. of the vehicle 100. The processor(s) 110 and/or the autonomous driving module(s) 160 may control some or all of these vehicle systems 140.

The processor(s) 110 and/or the autonomous driving module(s) 160 may be operable to control the navigation and/or maneuvering of the vehicle 100 by controlling one or more of the vehicle systems 140 and/or components thereof. For instance, when operating in an autonomous mode, the processor(s) 110, and/or the autonomous driving module(s) 160 can control the direction and/or speed of the vehicle 100. The processor(s) 110 and/or the autonomous driving module(s) 160 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, direct, command, instruct, and/or enable an event or action to occur or at least be in a state where such event or action may occur, either in a direct or indirect manner.

The vehicle 100 can include one or more actuators 150. The actuators 150 can be any element or combination of elements operable to modify, adjust and/or alter one or more of the vehicle systems 140 or components thereof to responsive to receiving signals or other inputs from the processor(s) 110 and/or the autonomous driving module(s) 160. Any suitable actuator can be used. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more autonomous driving modules 160. The autonomous driving module(s) 160 can be configured to receive data from the sensor system 120 and/or any other type of system capable of capturing information relating to the vehicle 100 and/or the external environment of the vehicle 100. In one or more arrangements, the autonomous driving module(s) 160 can use such data to generate one or more driving scene models. The autonomous driving module(s) 160 can determine position and velocity of the vehicle 100. The autonomous driving module(s) 160 can determine the location of obstacles, obstacles, or other environmental features including traffic signs, trees, shrubs, neighboring vehicles, pedestrians, etc.

The autonomous driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The autonomous driving module(s) 160 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 250 as implemented by the transmission module 230. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The autonomous driving module(s) 160 can be configured to implement determined driving maneuvers. The autonomous driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The autonomous driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, module as used herein includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A network system for a vehicle, the network system comprising:
a data bus;
a first sensor node in communication with the data bus;
a second sensor node in communication with the data bus;
a third sensor node in communication with the data bus; and
wherein the first sensor node comprises:
one or more processors,
a sensing element configured to sense at least one condition and generate sensor data based on the sensed at least one condition, the sensing element being in communication with the one or more processors,
a memory device in communication with the one or more processors, the memory device storing a communications module,
the communications module having instructions when executed by the one or more processors causes the one or more processors to receive input data from the second sensor node that the first sensor node is subscribed to via the data bus, the input data including data regarding at least one condition sensed by the second sensor node, and
the communications module having instructions when executed by the one or more processors causes the one or more processors to publish output data to a third sensor node that is subscribed to the first sensor node, the output data including data regarding the at least one condition sensed by the sensing element.

2. The network system of claim 1, wherein the memory device stores a data processing module having instructions when executed by the one or more processors of the first sensor node causes the one or more processors to:
compare the input data from the second sensor node with the sensor data generated by the sensing element of the first sensor node;
determine a data discrepancy error based on the comparison of the input data from the second sensor node with the sensor data generated by the sensing element of the first sensor node; and
publish an indicator of the data discrepancy error to the third sensor node that is subscribed to the first sensor node.

3. The network system of claim 1, further comprising a data processing module having instructions that when executed by the one or more processors causes the one or more processors to generate aggregated data that includes at least portions of the input data and at least portions of the sensor data.

4. The network system of claim 3, wherein the communications module further includes instructions that when executed by the one or more processors cause of the first sensor node to publish the aggregated data to the third sensor node that is subscribed to the first sensor node.

5. The network system of claim 1, wherein the second sensor node and the third sensor node are a same sensor node.

6. The network system of claim 1, wherein the first sensor node and the second sensor node are subscribed a subscription, wherein the subscription is related to a function of a vehicle.

7. A method for communication in a sensor network, the method comprising the steps of:
receiving input data by a first sensor node from a second sensor node that the first sensor node is subscribed to, the input data including data regarding at least one condition sensed by the second sensor node, and
publishing, by the first sensor node, output data to a third sensor node that is subscribed to the first sensor node, the output data including data regarding the at least one condition sensed by a sensing element of the first sensor node.

8. The method of claim 7, further comprising the steps of:
comparing, by the first sensor node, the input data from the second sensor node with sensor data generated by the sensing element;
determining, by the first sensor node, a data discrepancy error based on the comparison of the input data from the second sensor node with the sensor data generated by the sensing element; and
publishing, by the first sensor node, an indicator of the data discrepancy error to the third sensor node that is subscribed to the first sensor node.

9. The method of claim 7, further comprising the step of generating, by the first sensor node, aggregated data that includes at least portions of the input data and at least portions of sensor data generated by the sensing element.

10. The method of claim 9, further comprising the step of publishing, by the first sensor node, the aggregated data to the third sensor node that is subscribed to the first sensor node.

11. The method of claim 7, wherein the second sensor node and the third sensor node are a same sensor node.

12. The method of claim 7, wherein the first sensor node is mounted within a vehicle.

13. A sensor node comprising:
one or more processors;
a sensing element configured to sense at least one condition and generate sensor data based on the sensed at least one condition, the sensing element being in communication with the one or more processors;
a memory device in communication with the one or more processors, the memory device storing a communications module;
the communications module having instructions when executed by the one or more processors causes the one or more processors to receive input data from a first external sensor node that the sensor node is subscribed to, the input data including data regarding at least one condition sensed by the first external sensor node; and
the communications module having instructions when executed by the one or more processors causes the one or more processors to publish output data to a second external sensor node that is subscribed to the sensor node, the output data including data regarding the at least one condition sensed by the sensing element.

14. The sensor node of claim 13, further comprising a data processing module having instructions when executed by the one or more processors causes the one or more processors to:
compare the input data from the first external sensor node with the sensor data generated by the sensing element;
determine a data discrepancy error based on the comparison of the input data from the first external sensor node with the sensor data generated by the sensing element; and
publish an indicator of the data discrepancy error to second external sensor node that is subscribed to the sensor node.

15. The sensor node of claim 13, further comprising a data processing module having instructions when executed by the one or more processors causes the one or more processors to generate aggregated data that includes at least portions of the input data and at least portions of the sensor data.

16. The sensor node of claim 15, wherein the communications module further includes instructions that when executed by the one or more processors cause the one or more processors to publish the aggregated data to a second external sensor node that is subscribed to the sensor node.

17. The sensor node of claim 13, wherein the first external sensor node and the second external sensor node are a same sensor node.

18. The sensor node of claim 13, wherein the sensor node is mounted within a vehicle.

19. The sensor node of claim 18 wherein the sensor node and at least one of the first external sensor node and the second external sensor node is in communication with a data bus.

20. The sensor node of claim 13, wherein the sensor node and the second external sensor node are subscribed a subscription, wherein the subscription is related to a function of a vehicle.
